(19) United States
(12) Patent Application Publication
(10) Pub. No.: US 2010/0277857 A1
(43) Pub. Date: Nov. 4, 2010

(54) FIXING MECHANISM WITH ROTARY FIXTURES AND RELATED PORTABLE COMPUTER DEVICE

(76) Inventor: Kuang-Hung Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/652,732

(22) Filed: Jan. 5, 2010

(30) Foreign Application Priority Data
Apr. 30, 2009 (TW) 098207298

(51) Int. Cl. G06F 1/16; E05D 11/10

(52) U.S. Cl. 361/679.09; 16/321

(57) ABSTRACT

A fixing mechanism includes a housing whereon an opening and at least one slot are formed, a sliding component installed inside the housing in a slidable manner, at least one rotary component installed inside the housing, connected to the sliding component in a rotatable manner, and protruding from the slot partly for fixing a structure, an elastic component installed inside the housing and disposed on an end of the sliding component for providing an elastic force to the sliding component, and an actuating tool for passing through the opening on the housing to push the sliding component so that the rotary component rotates into the slot when being driven to hit a side of the slot.

### BACKGROUND OF THE INVENTION

1. Field of the Invention

The present invention relates to a fixing mechanism, and more particularly, to a fixing mechanism with rotary fixtures and a related portable computer device.

2. Description of the Prior Art

In general, assembly of a keyboard always takes much time and labor when fabricating a notebook computer. In the conventional procedure of assembling the keyboard is as follows: lifting the keyboard to keep a distance from a host, inserting a membrane cable of the keyboard into a connector on the host, covering the connector, and aiming hooks on the keyboard at corresponding slots on the host for locking the keyboard on the host at last. That is to say, the conventional procedure of assembling the keyboard utilizes screws mainly. But the above-mentioned procedure has disadvantage of difficult to disassembly or even incapability of disassembly. There is a need to design a fixing mechanism capable of assembling the keyboard easily and conveniently.

### SUMMARY OF THE INVENTION

The present invention provides a fixing mechanism with rotary fixtures and a related portable computer device for solving above drawbacks.

According to the claimed invention, a fixing mechanism includes a housing whereon an opening and at least one slot are formed, a sliding component installed inside the housing in a slidable manner, at least one rotary component installed inside the housing, connected to the sliding component in a rotatable manner, and protruding from the slot partly so as to fix a structure, an elastic component installed inside the housing and disposed on an end of the sliding component for providing an elastic force to the sliding component, and an actuating tool for passing through the opening on the housing to push the sliding component so that the rotary component rotates into the slot when being driven to hit a side of the slot.

According to the claimed invention, a sunken part is formed on a side of the housing for accommodating the structure, and the rotary component is for protruding from the slot and against a side of the structure so as to fix the structure inside the sunken part.

According to the claimed invention, the sliding component is a rod.

According to the claimed invention, a bolt is disposed on the sliding component, and a hole is formed on the rotary component for pivoting on the bolt.

According to the claimed invention, an inclined structure or an arc structure is formed on a side of the rotary component.

According to the claimed invention, the elastic component is a spring sheathing on the end of the sliding component.

According to the claimed invention, the actuating tool is a pin or a stylus.

According to the claimed invention, the housing includes an upper cover whereon the slot is disposed, and a lower cover for combining with the upper cover.

According to the claimed invention, the fixing mechanism further includes at least one hook disposed on an inner side of the upper cover for engaging with the sliding component.

According to the claimed invention, the hook and the slot are disposed on the upper cover alternately.

According to the claimed invention, the fixing mechanism further includes at least one supporting component disposed on an inner side of the lower cover for supporting the sliding component.

According to the claimed invention, the structure is a keyboard or a casing.

According to the claimed invention, a portable computer device includes a structure and a fixing mechanism for fixing the structure. The fixing mechanism includes a housing whereon an opening and at least one slot are formed, a sunken part is formed on a side of the housing for accommodating the structure, a sliding component installed inside the housing in a slidable manner, at least one rotary component installed inside the housing and connected to the sliding component in a rotatable manner for rotatably protruding from the slot and being against a side of the structure so as to fix the structure inside the sunken part, an elastic component installed inside the housing and disposed on an end of the sliding component for providing an elastic force to the sliding component, and an actuating tool for passing through the opening on the housing to push the sliding component so that the rotary component rotates into the slot when being driven to hit a side of the slot.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a portable computer device according to a preferred embodiment of the present invention.

FIG. 2 and FIG. 3 are exploded diagrams of partial components of the portable computer device at different views according to the preferred embodiment of the present invention.

FIG. 4 is an exploded diagram of a sliding component and a rotary component according to the preferred embodiment of the present invention.

FIG. 5 is a diagram of a supporting component supporting the sliding component on a lower cover according to the preferred embodiment of the present invention.

FIG. 6 is a diagram of a hook engaging the sliding component with an upper cover according to the preferred embodiment of the present invention.

FIG. 7 is an enlarged diagram of the portable computer device partly according to the preferred embodiment of the present invention.

FIG. 8 and FIG. 9 are diagrams of a fixing mechanism in a locked condition and a released condition respectively according to the preferred embodiment of the present invention.

### DETAILED DESCRIPTION

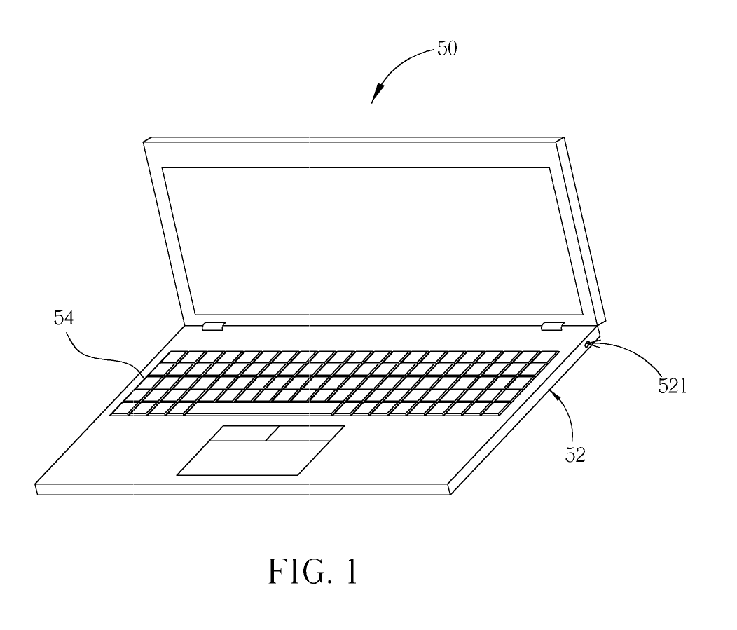

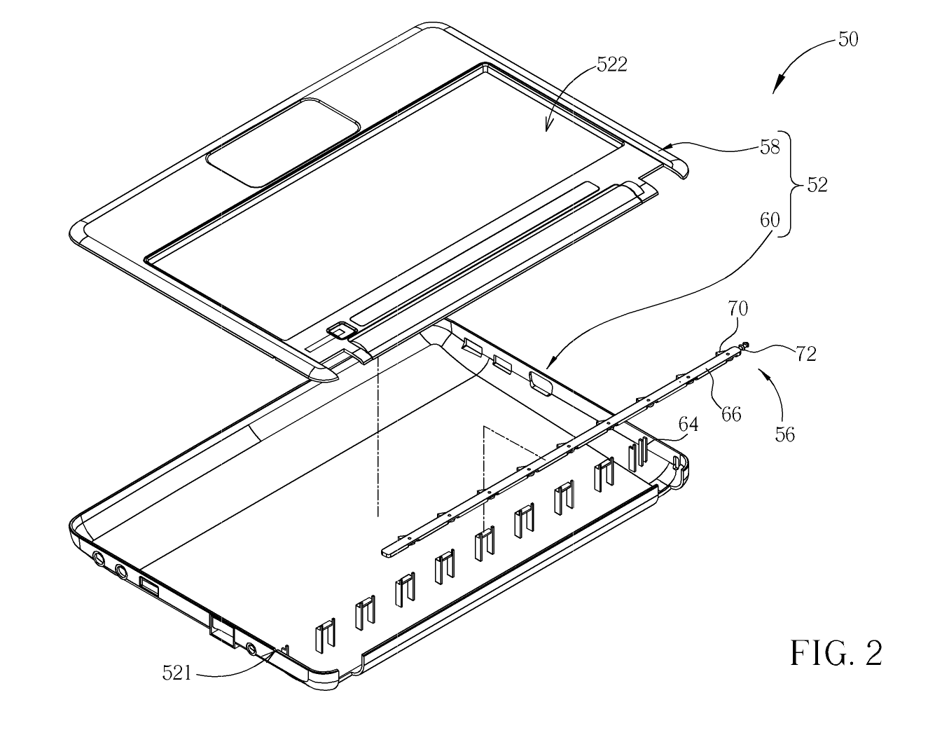

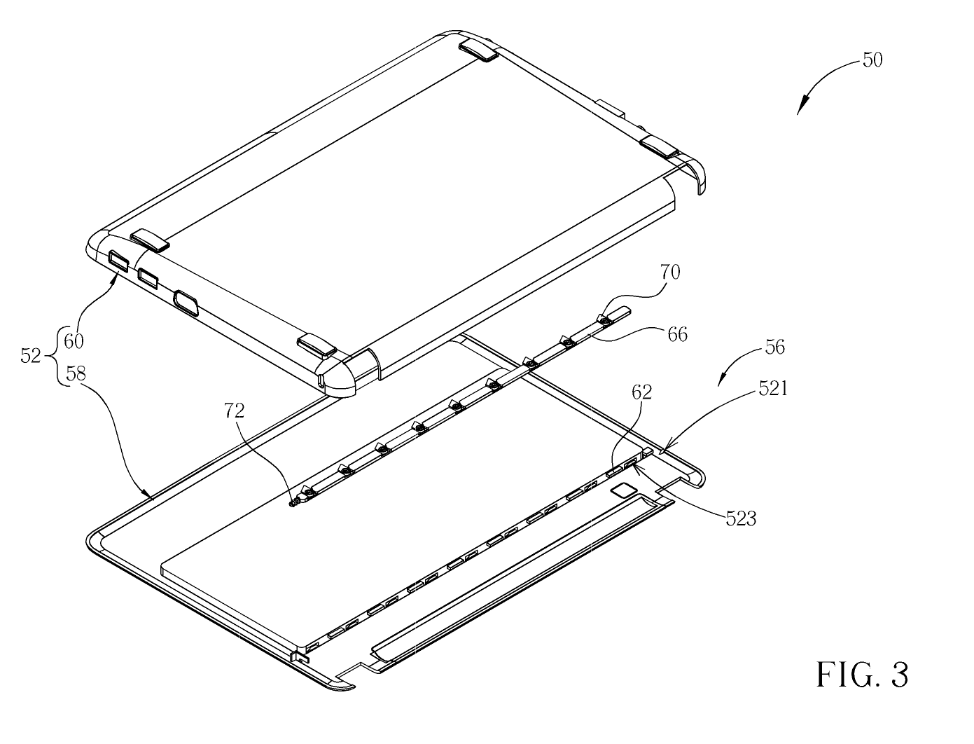

Please refer to FIG. 1. FIG. 1 is a diagram of a portable computer device 50 according to a preferred embodiment of the present invention. The portable computer device 50 can be a notebook computer. The portable computer device 50 includes a housing 52 for covering inner components, and a structure 54 installed on the housing 52. An opening 521 is formed on a lateral side of the housing 52. The structure 54 can be a keyboard. Please refer to FIG. 2 and FIG. 3. FIG. 2 and FIG. 3 are exploded diagrams of partial components of the portable computer device 50 at different views according to the preferred embodiment of the present invention. In order to illustrate the related components clearly, the structure 54 is omitted in FIG. 2 and FIG. 3. The portable computer device 50 includes a fixing mechanism 56, which can be a keyboard fixing mechanism. The fixing mechanism 56 includes the housing 52. The housing 52 includes an upper cover 58, and a lower cover 60 for combining with the upper cover 58. A sunken part 522 is formed on a side of the upper cover 58 for accommodating the structure 54. In addition, a plurality of slots 523 is formed on a side of the sunken part 522 of the upper cover 58, and a plurality of hooks 62 is disposed on an inner side of the upper cover 58. The hook 62 can be integrated with the upper cover 58 monolithically. The hook 62 and the slot 523 can be disposed on the upper cover 58 alternately. A plurality of supporting components 64 is disposed on an inner side of the lower cover 60, which can be integrated with the lower cover 60 monolithically. The supporting component 64 can also be a reverse U-shaped strip structure, which means the plurality of separating components can be integrated as a single component, and it depends on actual demand.

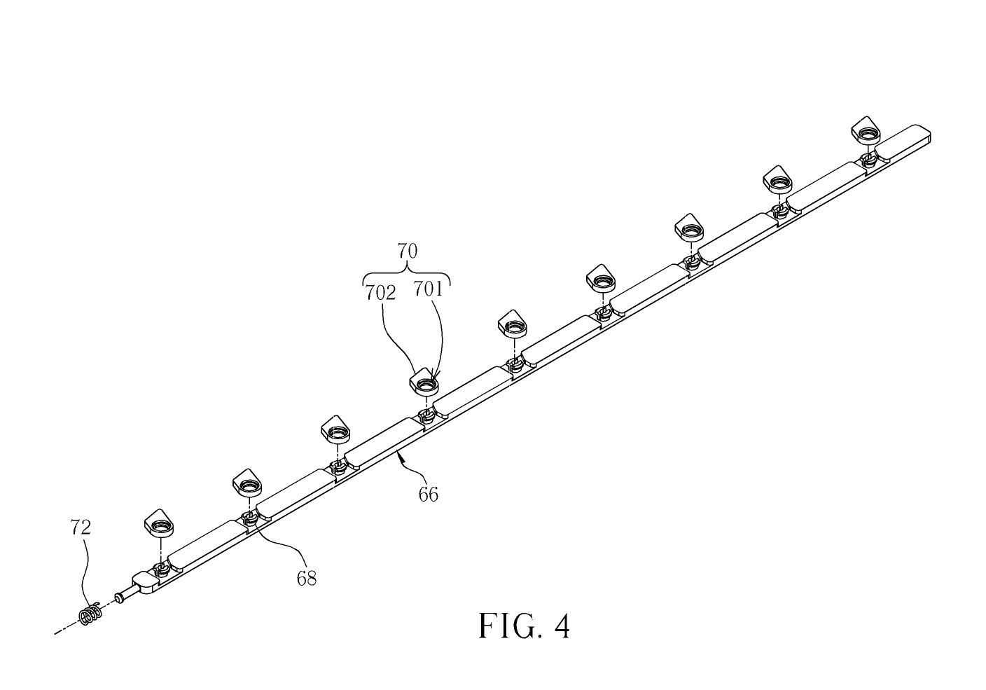

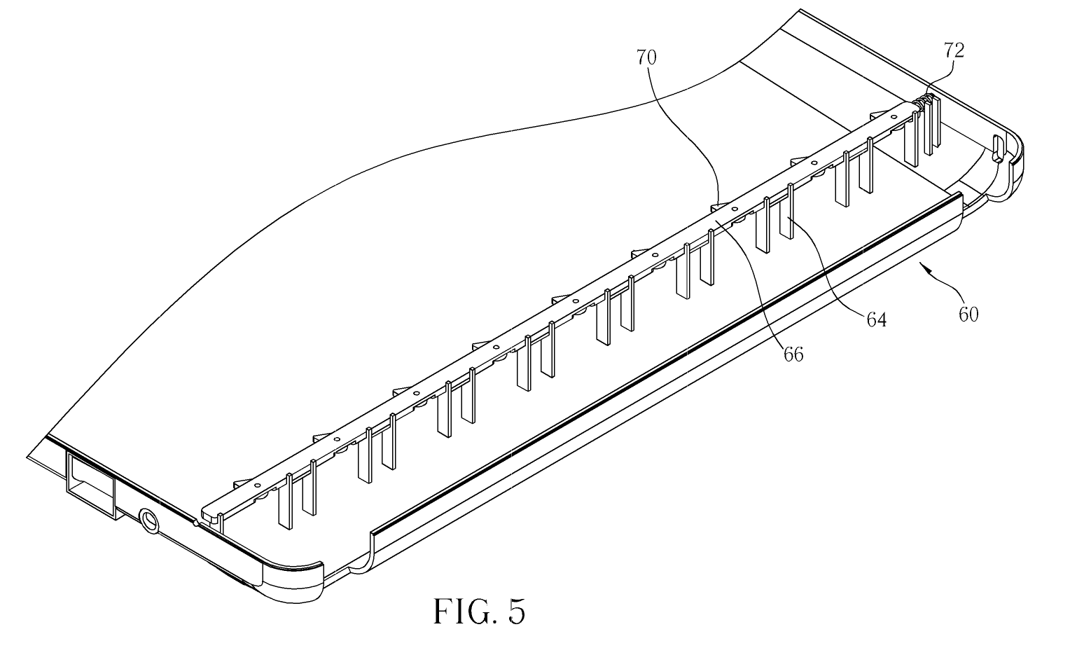

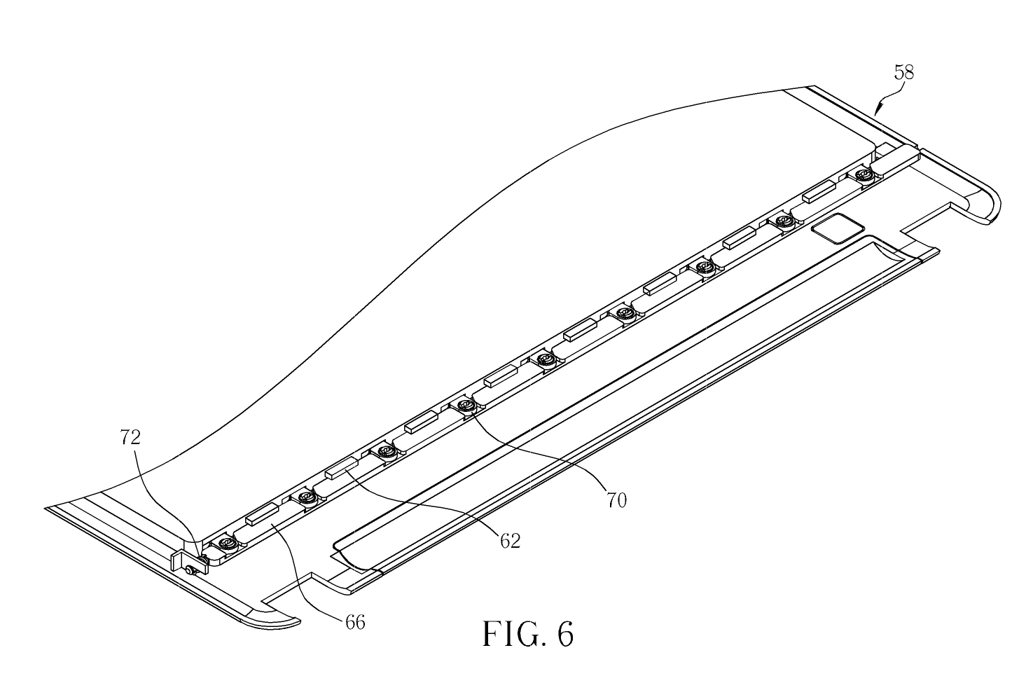

The fixing mechanism 56 further includes a sliding component 66 installed inside the housing 52 in a slidable manner. The sliding component 66 can be a rod. A plurality of bolts 68 is disposed on the sliding component 66. The fixing mechanism 56 further includes a plurality of rotary components 70 installed inside the housing 52 and connected to the sliding component 66 in a rotatable manner. Please refer to FIG. 4, FIG. 4 is an exploded diagram of the sliding component 66 and the rotary component 70 according to the preferred embodiment of the present invention. A hole 701 is formed on each rotary component 70 for pivoting on each bolt 68 of the sliding component 66, so that the rotary component 70 can rotate relative to the sliding component 66. In addition, an inclined structure 702 is formed on a side of each rotary component 70. The inclined structure 702 can be replaced by an arc structure. The fixing mechanism 56 further includes an elastic component 72 installed inside the housing 52 and disposed on an end of the sliding component 66 away from the opening 521 of the housing 52. The elastic component 72 can be a spring sheathing on the end of the sliding component 66 for providing an elastic force to the sliding component 66. The elastic component 72 can also be an elastic clip, etc. Please refer to FIG. 5 and FIG. 6. FIG. 5 is a diagram of the supporting component 64 supporting the sliding component 66 on the lower cover 66 according to the preferred embodiment of the present invention. FIG. 6 is a diagram of the hook 62 engaging the sliding component 66 with the upper cover 58 according to the preferred embodiment of the present invention. The plurality of supporting components 64 on the lower cover 60 can support the sliding component 66, and the plurality of hooks 62 can engage the sliding component 66 with the upper cover 58. Thus, the sliding component 66 can be fixed between the upper cover 58 and lower cover 60. Assembling consequence of the fixing mechanism 56 is installing the elastic component 72 and the rotary components 70 on the sliding component 66 first, inserting the sliding component 66 into the hook 62 of the upper cover 58 diagonally, and combining the lower cover 60 with the upper cover 58 at last. Therefore, the sliding component 66 can be fixed between the upper cover 58 and the lower cover 60.

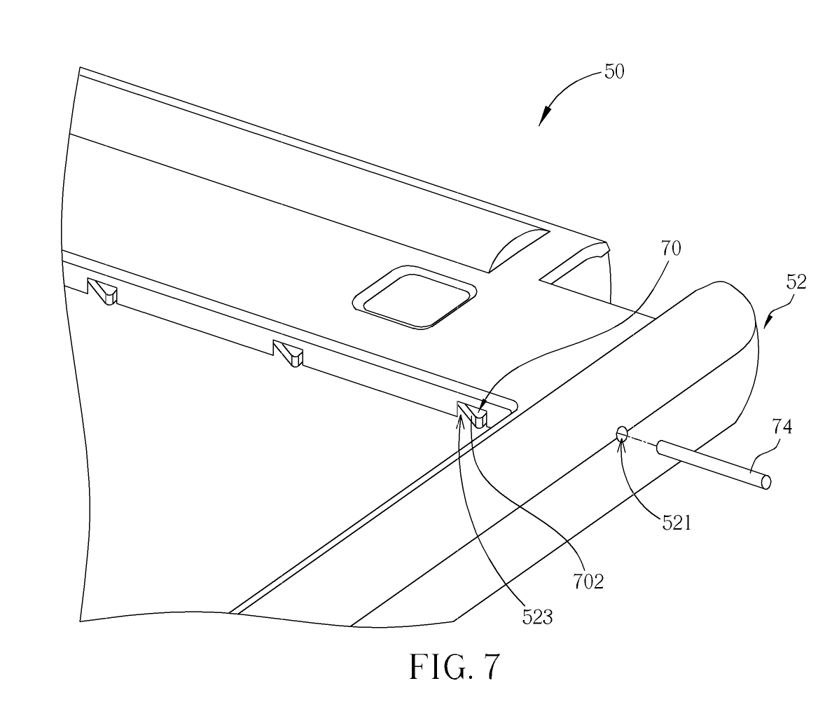

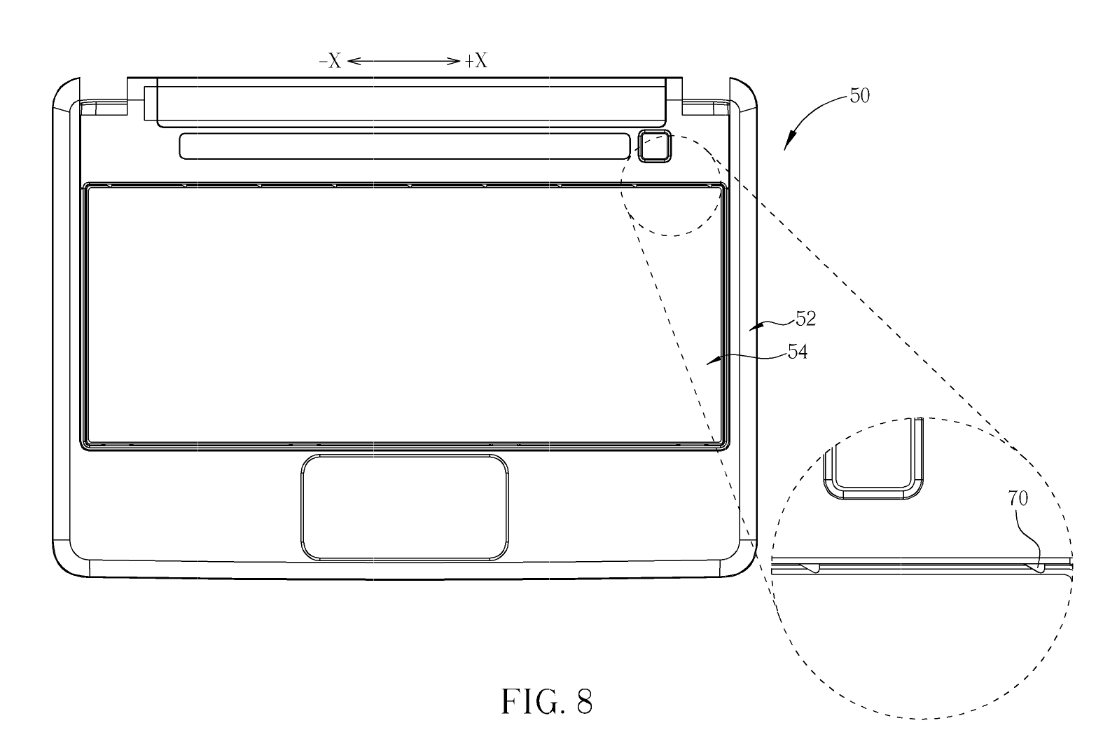

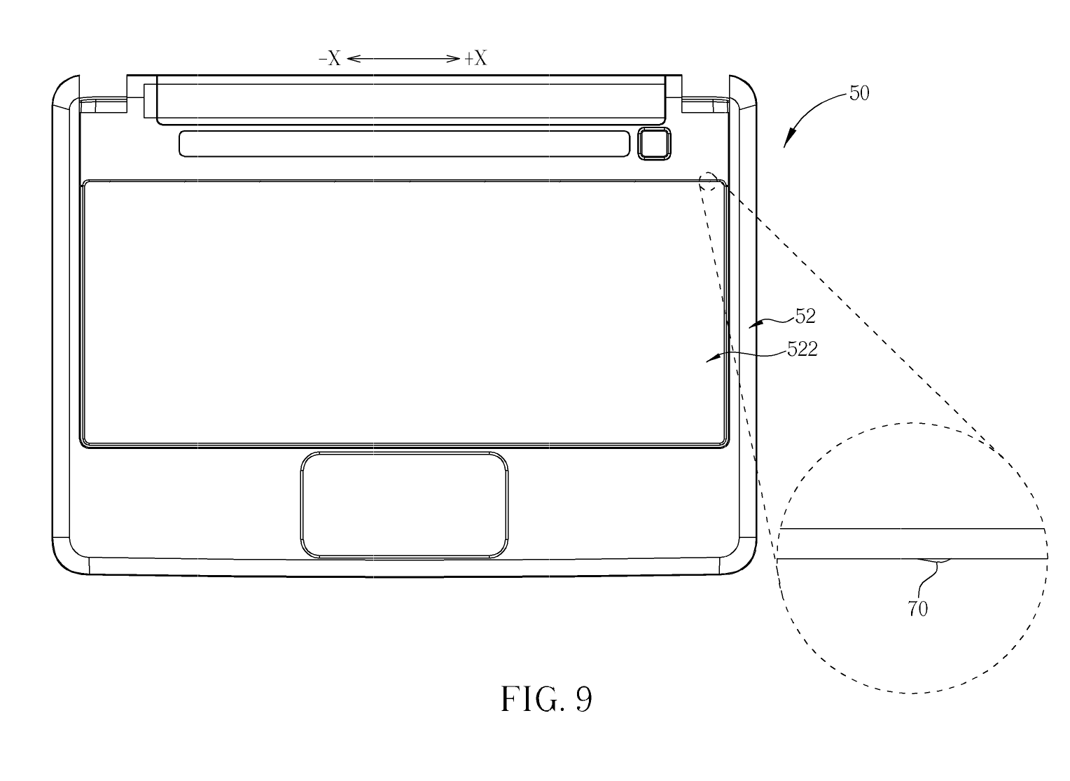

Please refer to FIG. 7. FIG. 7 is an enlarged diagram of the portable computer device 50 partly according to the preferred embodiment of the present invention. The portable computer device 50 further includes an actuating tool 74 for passing through the opening 521 on the housing 52 to push the sliding component 66. The actuating tool 74 can be a pin, a stylus, and so on. Any tool capable of pushing the sliding component 66 belongs to the scope of the actuating tool 74 of the present invention. The rotary component 70 protrudes from the slot 523 partly so as to fix the structure 54. Please refer to FIG. 2 to FIG. 9. FIG. 8 and FIG. 9 are diagrams of the fixing mechanism 56 in a locked condition and a released condition respectively according to the preferred embodiment of the present invention. As shown in FIG. 8, when the fixing mechanism 56 is locked, an angle of the rotary component 70 protruding from the slot 523 partly can be 30 degrees substantially (not be limited in this angle), and the rotary component 70 can be against an upper side of the structure 54 so as to fix the structure 54 on the housing 52. When a user disassembles the structure 54, the actuating tool 74 can be inserted into the opening 521 on the housing 52 to push the sliding component 66. Therefore, the sliding component 66 moves in a −X direction until the inclined structure 702 of the rotary component 74 hits a side of the slot 523. At this time, the elastic component 72 on the other end of the sliding component 66 is compressed. Because a lateral wall of the slot 523 applies a normal force to the inclined structure 702 of the rotary component 70, the rotary component 70 rotates into the slot 523 so that the fixing mechanism 56 can be released. As shown in FIG. 9, when the fixing mechanism 56 is released, the angle of the rotary component 70 protruding from the slot 523 can be 10 degrees substantially (not be limited in this angle), which means the rotary component 70 can not be against the upper side of the structure 54 effectively, so that the structure 54 can not be fixed on the housing 52. Therefore, the user can disassemble the structure 54 easily.

On the other hand, when the user assembles the structure 54 on the housing 52, the structure 54 can be disposed inside the sunken part 522 of the housing 52 first, and the actuating tool 74 is drawn out of the opening 521 on the housing 52. Meanwhile, the elastic component 72 on the other end of the sliding component 66 is not compressed anymore so as to provide the recovering elastic force to the sliding component 66. Therefore, the sliding component 66 is pushed by the elastic component 72 in a +X direction until the rotary component 70 hits the other side of the slot 523. Because a lateral wall of the other side of the slot 523 applies a normal force to the rotary component 70, the rotary component 70 rotates out of the slot 523, so that the fixing mechanism 56 is locked again. Besides, the user can rotate the rotary component 70 out of the slot 523 by oneself, so that the rotary component 70 can be against the upper side of the structure 54 so as to fix the structure 54 on the housing 52.

In addition, the fixing mechanism of the present invention can not be limited for fixing the keyboard device. For example, the fixing mechanism can be used for fixing an external cover, such as a CPU cover, a battery cover, or a memory cover, and it depends on actual demand.

Comparing to the prior art, the fixing mechanism and the related portable computer device of the present invention utilizes rotary fixtures to fix the keyboard. The present invention can solve inconvenience of disassembling the keyboard on the notebook computer. The fixing mechanism is utilized without screws, and it can reduce difficulty of assembly and can economize labor hours and manufacturing cost.

Those skilled in the art will readily observe that numerous modifications and alterations of the device and method may be made while retaining the teachings of the invention.

What is claimed is:

1. A fixing mechanism comprising:
a housing whereon an opening and at least one slot are formed;
a sliding component installed inside the housing in a slidable manner;
at least one rotary component installed inside the housing, connected to the sliding component in a rotatable manner, and protruding from the slot partly so as to fix a structure;
an elastic component installed inside the housing and disposed on an end of the sliding component for providing an elastic force to the sliding component; and
an actuating tool for passing through the opening on the housing to push the sliding component so that the rotary component rotates into the slot when being driven to hit a side of the slot.

2. The fixing mechanism of claim 1, wherein a sunken part is formed on a side of the housing for accommodating the structure, and the rotary component is for protruding from the slot and against a side of the structure so as to fix the structure inside the sunken part.

3. The fixing mechanism of claim 1, wherein the sliding component is a rod.

4. The fixing mechanism of claim 1, wherein a bolt is disposed on the sliding component, and a hole is formed on the rotary component for pivoting on the bolt.

5. The fixing mechanism of claim 1, wherein an inclined structure or an arc structure is formed on a side of the rotary component.

6. The fixing mechanism of claim 1, wherein the elastic component is a spring sheathing on the end of the sliding component.

7. The fixing mechanism of claim 1, wherein the actuating tool is a pin or a stylus.

8. The fixing mechanism of claim 1, wherein the housing comprises an upper cover whereon the slot is disposed, and a lower cover for combining with the upper cover.

9. The fixing mechanism of claim 8 further comprising:
at least one hook disposed on an inner side of the upper cover for engaging with the sliding component.

10. The fixing mechanism of claim 9, wherein the hook and the slot are disposed on the upper cover alternately.

11. The fixing mechanism of claim 8 further comprising:
at least one supporting component disposed on an inner side of the lower cover for supporting the sliding component.

12. The fixing mechanism of claim 1, wherein the component is a keyboard or a casing.

13. A portable computer device comprising:
a structure; and
a fixing mechanism for fixing the structure, the fixing mechanism comprising:
a housing whereon an opening and at least one slot are formed, a sunken part being formed on a side of the housing for accommodating the structure;
a sliding component installed inside the housing in a slidable manner;
at least one rotary component installed inside the housing and connected to the sliding component in a rotatable manner for rotatably protruding from the slot and being against a side of the structure so as to fix the structure inside the sunken part;
an elastic component installed inside the housing and disposed on an end of the sliding component for providing an elastic force to the sliding component; and
an actuating tool for passing through the opening on the housing to push the sliding component so that the rotary component rotates into the slot when being driven to hit a side of the slot.

14. The portable computer device of claim 13, wherein a bolt is disposed on the sliding component, and a hole is formed on the rotary component for pivoting on the bolt.

15. The portable computer device of claim 13, wherein an inclined structure or an arc structure is formed on a side of the rotary component.

16. The portable computer device of claim 13, wherein the elastic component is a spring sheathing on the end of the sliding component.

17. The portable computer device of claim 13, wherein the housing comprises an upper cover whereon the slot is disposed and a lower cover for combining with the upper cover.

18. The portable computer device of claim 17, wherein the fixing mechanism further comprises at least one hook disposed on an inner side of the upper cover for engaging with the sliding component.

19. The portable computer device of claim 18, wherein the hook and the slot are disposed on the upper cover alternately.

20. The portable computer device of claim 17, wherein the fixing mechanism further comprises at least one supporting component disposed on an inner side of the lower cover for supporting the sliding component.
